(19) United States
(12) Patent Application Publication
(10) Pub. No.: US 2017/0055706 A1
(43) Pub. Date: Mar. 2, 2017

(54) MODULAR DISPLAY CASE

(71) Applicant: Robert Carson MATAXIS, Raleigh, NC (US)

(72) Inventor: Robert Carson MATAXIS, Raleigh, NC (US)

(21) Appl. No.: 14/836,016

(22) Filed: Aug. 26, 2015

(51) Int. Cl. A47B 87/02; G09F 15/00; A47F 5/10

(52) U.S. Cl. CPC A47B 87/0292; A47F 5/10; G09F 15/0068

(57) ABSTRACT

A stand-alone display case module is provided. Each display case module has a first modular connector and a second modular connector mounted to opposing vertical walls, wherein a rod member may slidably engage the nesting of the first modular connector of one display case module and the second modular connector of another display case module so as to form a pivotal modular connection between at least two adjacent display case modules, and wherein the adjacent display case modules are pivotably connected in horizontal and/or vertically stacked configurations.

### BACKGROUND OF THE INVENTION

The present invention relates to display cases and, more particularly, to a stand-alone display case module with a hinge and segmented rod system for connecting to other adjacent display case modules in horizontal and/or vertically stacked configurations.

Once a collector acquires more collectibles than their single display case will hold, they often have to buy a second standalone case, resulting in two groups of collectibles rather than one large collection, because current display cases do not grow seamlessly with their collections. In other words, existing display cases are not modular as they cannot combine dozens of cases vertically and horizontally for one large seamless display. As a result, currently collectors jumble together a plethora of single standalone cases, or they custom build cases or shelves when displaying their cherished collectibles.

As can be seen, there is a need for a stand-alone display case module with a hinge and segmented rod system for connecting to other adjacent display case modules in horizontal and/or vertically stacked configurations.

### SUMMARY OF THE INVENTION

In one aspect of the present invention, a display case module adapted for modular engagement with other ones of said display case module, the display case module includes two opposing vertical walls; at least one horizontal wall extending between the two vertical walls; a first modular connector mounted to one of the two opposing vertical walls; a second modular connector mounted to another of the two opposing vertical walls; at least one rod member adapted to engage a first portion of both modular connectors, wherein said display case module is adapted to form a pivotal modular connection between adjacent said display case modules by an engagement of the second modular connector of one said display case module, the first modular connector of the adjacent said display case module, and the rod member, whereby the pivotal modular connection pivotally connects the adjacent said display case modules.

In another aspect of the present invention, a display case modular system, includes a first and second display case module adapted for modular engagement with each other, the first display case module includes two opposing vertical walls; at least one horizontal wall extending between the two vertical walls; a first modular connector mounted to one of the two opposing vertical walls; the second display case module includes two opposing vertical walls; at least one horizontal wall extending between the two vertical walls; a second modular connector mounted to another of the two opposing vertical walls; a rod member adapted to engage a portion of both modular connectors, wherein the first display case module is adapted to form a pivotal modular connection between the second display case module by an engagement of the second modular connector, the first modular connector, and the rod member, whereby the pivotal modular connection pivotally connects the first and second display case modules.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is an exploded perspective view of an exemplary embodiment of the present invention;

FIG. 3 is an exploded detail perspective view of an exemplary embodiment of the present invention;

FIG. 4 is a detail perspective view of an exemplary embodiment of the present invention;

FIG. 5 is an exploded perspective view of an exemplary embodiment of the present invention, demonstrating the formation of a pivotal modular connection, in the liner configuration;

FIG. 6 is an exploded perspective view of an exemplary embodiment of the present invention;

FIG. 7 is a perspective view of an exemplary embodiment of the present invention;

FIG. 8 is a detail exploded perspective view of an exemplary embodiment of the present invention;

FIG. 9 is an detail perspective view of an exemplary embodiment of the present invention; and

FIG. 10 is a perspective view of an exemplary embodiment of a system of the present invention, formed in both the linear and stacked configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a stand-alone display case module having a first modular connector and a second modular connector mounted to opposing vertical walls, wherein a rod member may slidably engage the nesting of the first modular connector of one display case module and the second modular connector of another display case module so as to form a pivotal modular connection between at least two adjacent display case modules, and wherein the adjacent display case modules are pivotably connected in horizontal and/or vertically stacked configurations.

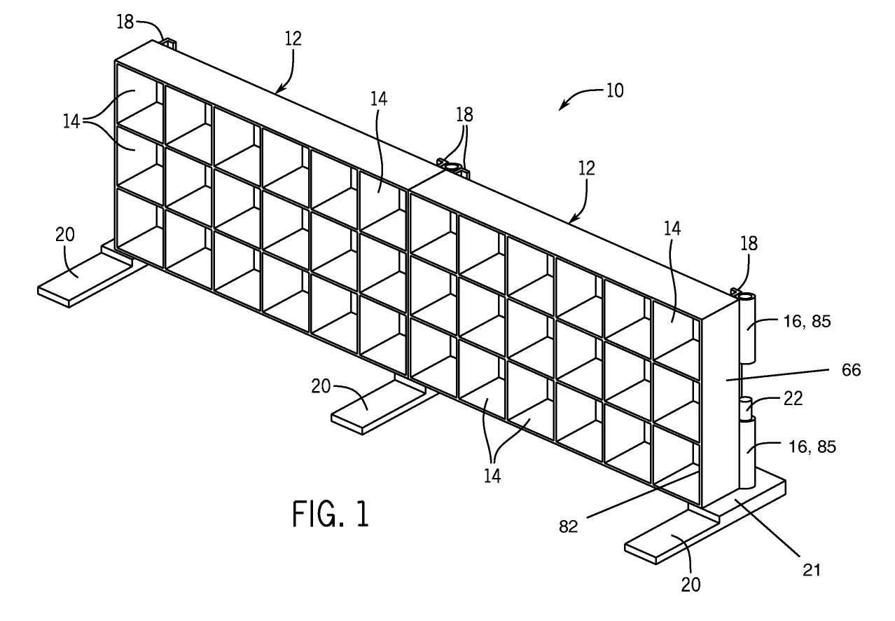

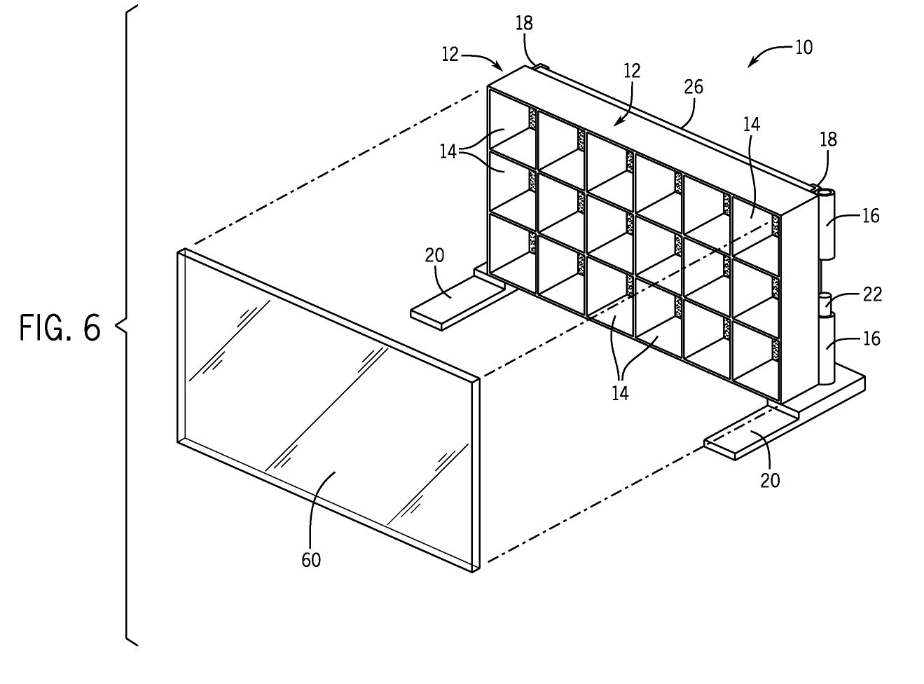

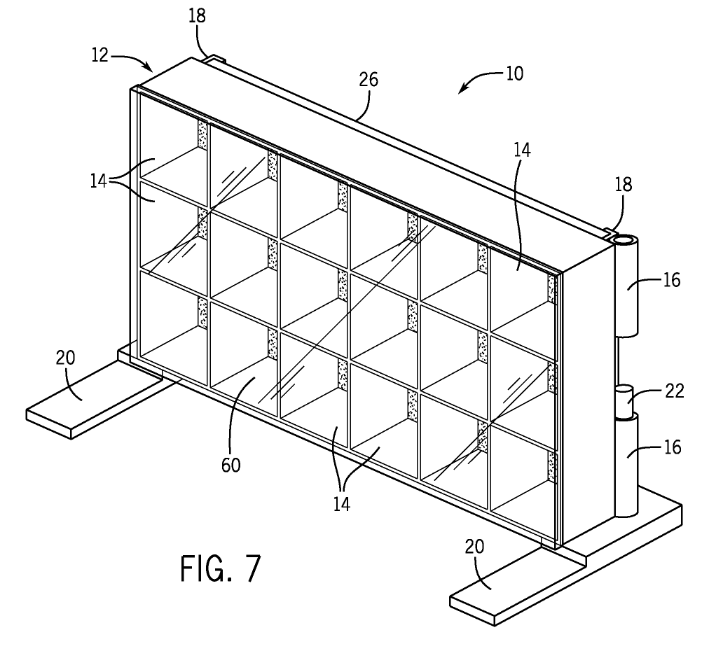

Referring to FIGS. 1 through 10, the present invention may include a display case module 12. Each display case module 12 may be adapted to form a pivotal modular connection 100 between an adjacent display case module 12 so as to form a system of display case modules 10 for displaying or storing collectibles, as illustrated in FIG. 1.

Each display case module 12 may include two opposing vertical walls 66, wherein at least one horizontal wall 68 extends between peripheral edges of the two opposing vertical walls 66 for form a generally rectangular compartment area. At least one internal horizontal member 70 may extend between the two opposing vertical walls 66, forming at least one shelf portion. At least one internal vertical member 72 may extend between a horizontal member 70 and an adjacent horizontal member 70 or the at least one horizontal wall 68, forming a plurality of sub-compartments 14, 32 within the at least one shelf portion/compartment area.

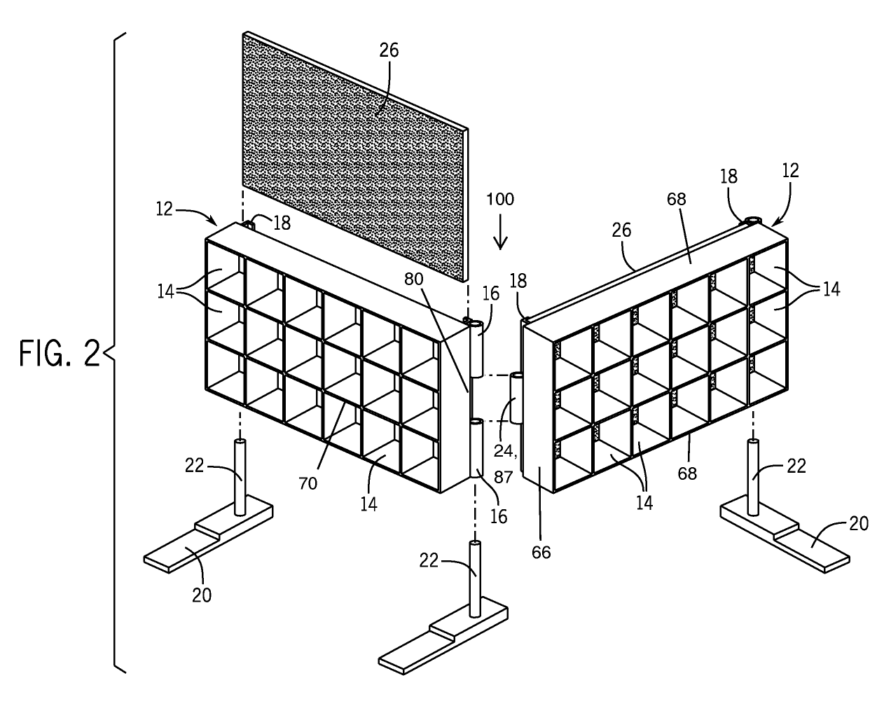

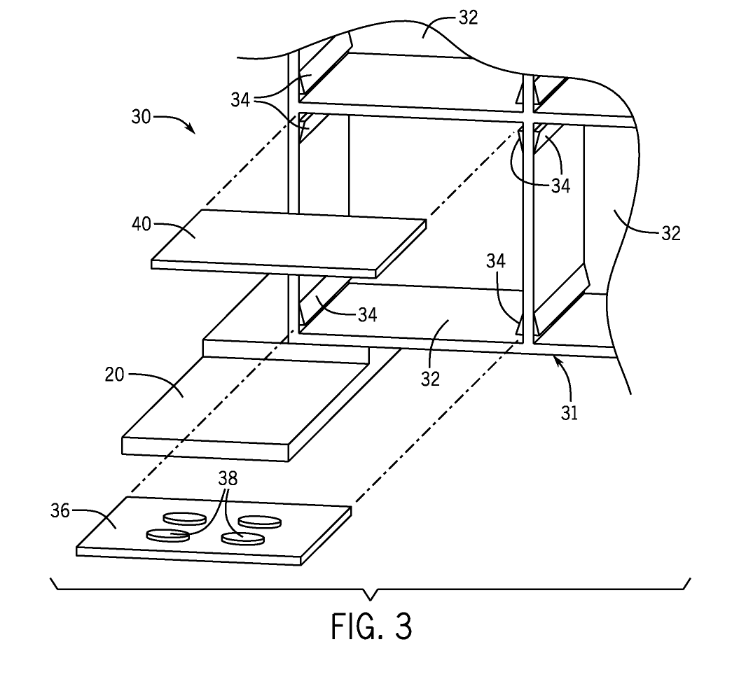

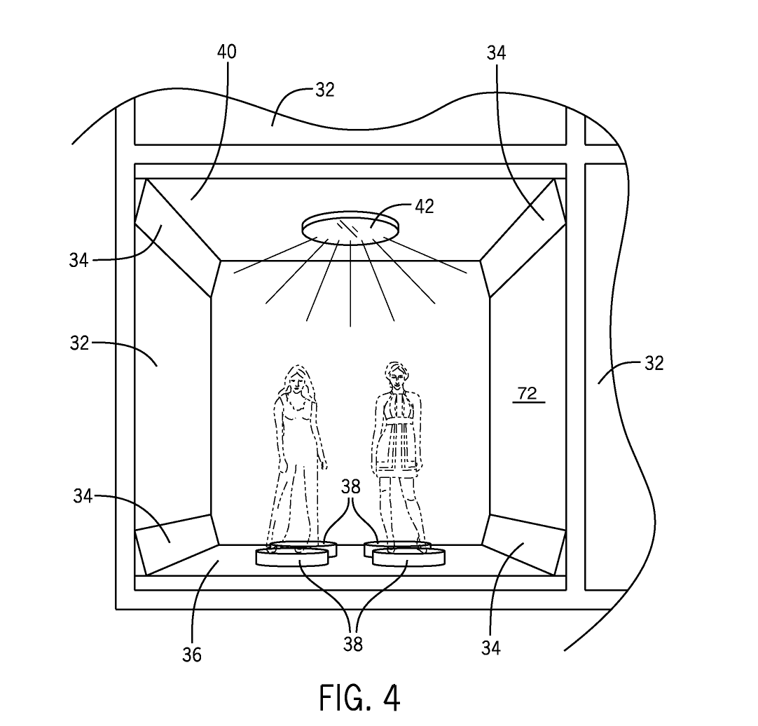

As a result, each display case module 12 may be a free-standing display case. Along those lines, each sub-compartment 32 may include a plurality of ledges 34 disposed therein for supporting floor and ceiling tiles 36, 40, as illustrated in FIG. 3. Furthermore, a plurality of pegs 38 may be disposed on the floor tiles 36 and a light source 42 may be disposed on the ceiling tiles for prominently displaying a plurality of collectibles, as illustrated in FIG. 4. A plurality of partition retainers 18 are molded into to the display case module 12 (along the back vertical and bottom horizontal edges) for retaining a customizable background 26 behind the back side of the clear display case module 12, as illustrated in FIG. 2. A transparent durable polypropylene front cover 60 snaps onto the display case, covering an otherwise open compartment area and/or sub-compartments 32.

Referring to FIGS. 1 and 2, the present invention embodies a pivotal modular connection 100 having a first modular connector 16, a second modular connector 24, and a rod member 22. The pivotal modular connection may be operable by nesting the first modular connector 16 and the second modular connector 24 so that the rod member 22 may operably engage a portion of both modular connectors 16, 24, wherein the first modular connector 16 is mounted to one display case module 12 and the second modular connection 24 is mounted to another, adjacent display case module 12, forming a linear configuration of the system 10, as illustrated in FIG. 1.

In certain embodiments, the first and second modular connectors 16, 24 include first and second tubular elements 85, 87, respectively, dimensioned and adapted so that when the modular connectors 16, 24 are nested, the tubular lumen of each tubular element 85, 87 align. The rod member 22 may be dimensioned and adapted to slidably be received in at least a portion of each modular connectors 16, 24, wherein the rod member 22 snugly slides through the tubular lumen formed by each modular connector 16, 24, so that the resulting pivotal modular connection 100 enables the two pivotally connected adjacent display case modules 12 to be pivoted about at least one vertical axis, so as to be adjustable to fit within the contours of nearly any room or as desired for display purposes.

Each modular connector 16, 24 may be mounted to each of the vertical walls 66. In a preferred embodiment, the modular connectors 16, 24 are disposed along a first peripheral side 80; though, they can be mounted near the first peripheral side 80, on the opposing second peripheral side 82, or anywhere in between.

The first modular connector 16 may be two spaced apart tubular elements 85, and the second modular connector 24 is one tubular element 87, the latter dimensioned to snugly fit between the two spaced apart tubular elements 85, when nested to form the pivotal modular connection 100, as illustrated in FIG. 2.

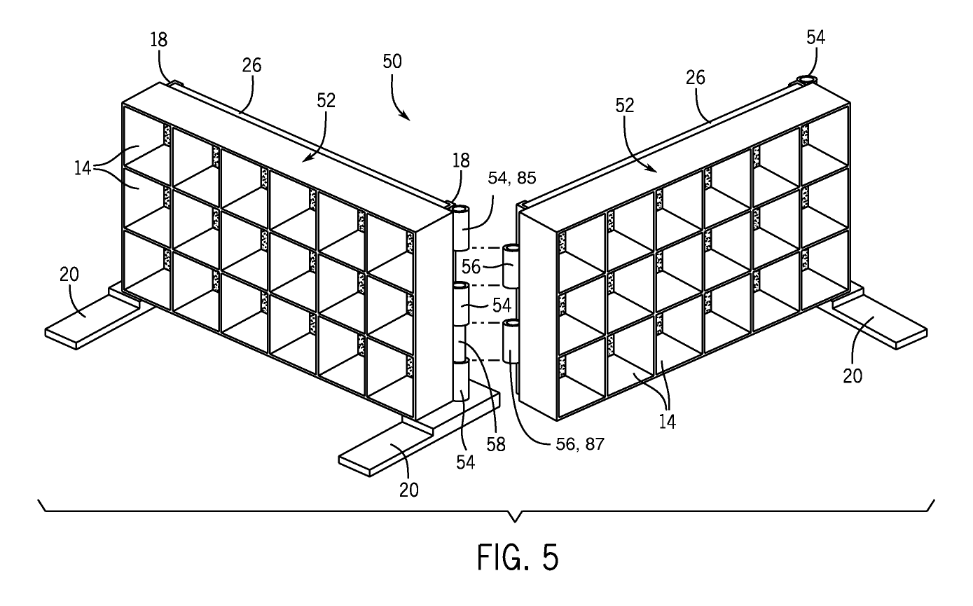

Referring to FIG. 5, a second embodiment of the display case module 52 may include a first modular connector 54 having three spaced apart tubular elements 85, wherein the second modular connector 56 includes two spaced apart tubular elements 87, the latter dimensioned to snugly fit between said three spaced apart tubular elements 85, when forming a second pivotal modular connection 50. Accordingly, a rod second member 58 may be dimensioned to slidably engage a portion of both modular connectors 54, 56.

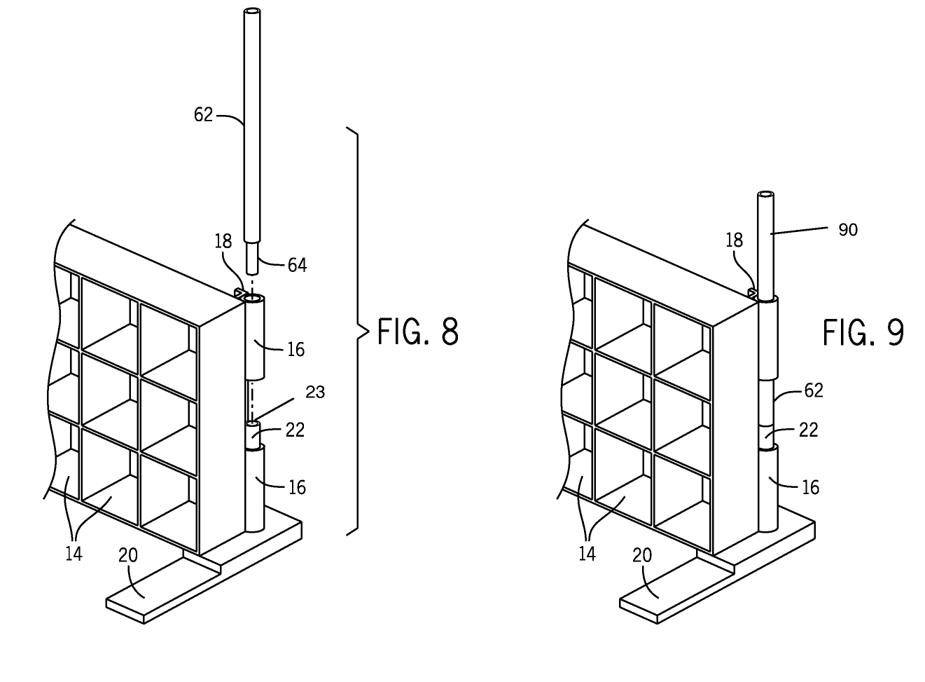

The rod member 22 may form a tubular aperture 23 disposed in one distal end, as illustrated in FIG. 8. In certain embodiments, the rod member 22 may be perpendicularly joined to a footing 22 at its proximal end, wherein the footing 22 may be dimensioned and adapted to support the display case module 12 or 52. The footing 22 may form a support surface 21 adapted to support a bottom side of at least one vertical wall and a portion of a horizontal wall 68, as illustrated in FIG. 1.

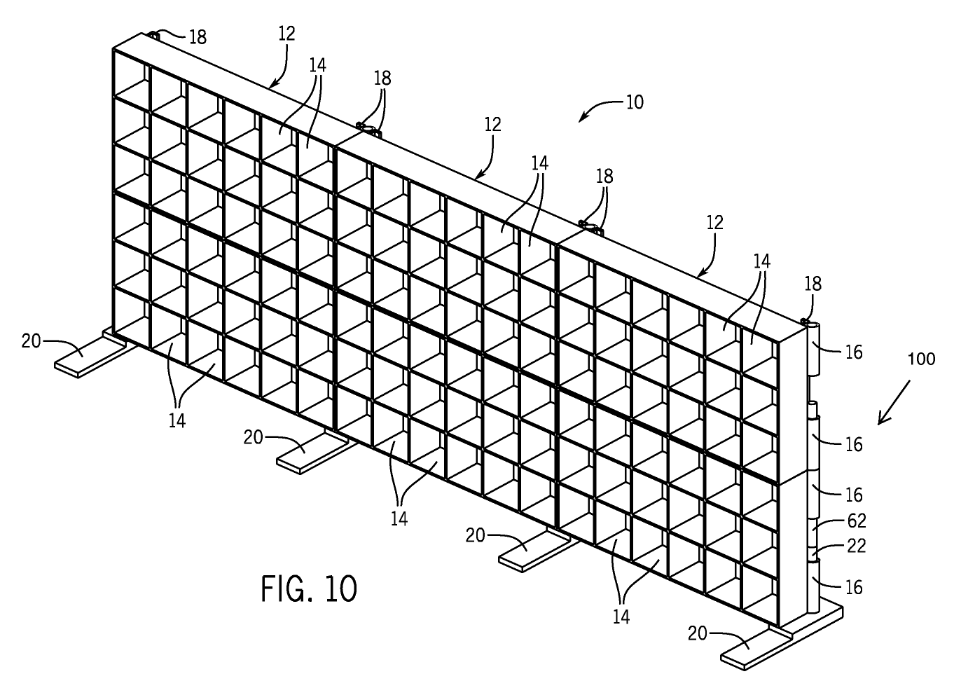

For vertical stacking, wherein a plurality of display modules 12 are connected to form a stacked configuration, as illustrated in FIG. 10, the present invention may include a vertical rod member 62 having an aperture protrusion 64 extending from one of its ends, as illustrated in FIG. 8. The aperture protrusion 64 is dimensioned and adapted to slidably engage the tubular aperture 23 as a downward portion of the vertical rod member 62 engagingly slides through at least one tubular element 16 so that an upward portion 90 of the vertical rod member 62 protrudes therefrom, as illustrated in FIG. 9. The upward portion 90 of the vertical rod member 62 enables engagement of a vertically adjacent display case module 12 or 52 so as to engage at least a portion of the modular connectors 16, 24 or 54, 56 of said vertically adjacent display case module 12 or 52, forming the stacked configuration of the system 10, as illustrated in FIG. 10.

A method of using the present invention may include the following. The display case module 12 or 52 disclosed above may be provided. A user may set the footing 20 on a floor/ground so that the rod member 22 extends vertically upward relative to the floor/ground. Then the user can by nest the first modular connector 16 of one display case module 12 and the second modular connector 24 of another display case module 12 so as to operably slide the rod member 16 through at least a portion of the aligned tubular elements 85 and 87. Now the two adjacent display case modules 12 may pivot relative to each other to fit within the contours of the room or be arranged as the collector desires, including a lined-up arrangement of the linear configuration of the system, as illustrated in FIG. 1.

Then the user may slide the vertical rod member 62 through a remaining portion of the aligned tubular elements 85, 87 so that its upward portion 90 protrudes there above, and the aperture protrusion 64 secures into the tubular aperture 23. Then the user may form the stacked configuration of the system 10 by placing at least one additional display case module 12 one or both of the two adjacent display case modules 12 so that the stacked modular connectors 16 or 24 slidably engage the protruding vertical rod member 62.

It should be understood, of course, that the foregoing relates to exemplary embodiments of the invention and that modifications may be made without departing from the spirit and scope of the invention as set forth in the following claims.

What is claimed is:

1. A display case module adapted for modular engagement with other ones of said display case module, the display case module comprising:
two opposing vertical walls;
at least one horizontal wall extending between the two vertical walls;
a first modular connector mounted to one of the two opposing vertical walls;
a second modular connector mounted to another of the two opposing vertical walls;
at least one rod member adapted to engage a first portion of both modular connectors,
wherein said display case module is adapted to form a pivotal modular connection between adjacent said display case modules by an engagement of the second modular connector of one said display case module, the first modular connector of the adjacent said display case module, and then at least one rod member,
whereby the pivotal modular connection pivotally connects the adjacent said display case modules.

2. The display case module of claim 1, further comprising a footing perpendicularly joined to each rod member.

3. The display case module of claim 2, wherein the footing forms a supporting surface adapted to support at least one of a bottom side of at least one vertical wall or a portion of a horizontal wall.

4. The display case module of claim 1, wherein the engagement comprises at least two spaced apart first tubular elements, wherein the second modular connector comprises at least one second tubular element, and wherein the pivotal modular connection includes snugly nesting said first and second tubular elements.

5. The display case module of claim 4, wherein the engagement comprises the rod member slidably being received into a first portion of the modular connectors.

6. The display case module of claim 1, wherein the engagement comprises two spaced apart first tubular elements, wherein the second modular connector comprises one second tubular element, and wherein the pivotal modular connection includes snugly nesting said first and second tubular elements.

7. The display case module of claim 1, wherein the engagement comprises three spaced apart first tubular elements, wherein the second modular connector comprises two spaced apart second tubular elements, and wherein the pivotal modular connection includes snugly nesting said first and second tubular elements.

8. The display case module of claim 5, further comprising at least one vertical rod member dimensioned and adapted so as to slidably engage a remaining portion of both modular connectors, wherein an upward portion of the at least one vertical rod member protrudes from said remaining portion of both modular connectors.

9. The display case module of claim 8, wherein each rod member forms a tubular aperture, wherein each vertical rod member forms an aperture protrusion dimensioned to snugly slide into the tubular aperture.

10. A display case modular system, comprising:
a first and second display case module adapted for modular engagement with each other, the first display case module comprising:
two opposing vertical walls;
at least one horizontal wall extending between the two vertical walls;
a first modular connector mounted to one of the two opposing vertical walls;
the second display case module comprising:
two opposing vertical walls;
at least one horizontal wall extending between the two vertical walls;
a second modular connector mounted to another of the two opposing vertical walls;
at least one rod member adapted to engage a portion of both modular connectors,
wherein the first display case module is adapted to form a pivotal modular connection between the second display case module by an engagement of the second modular connector, the first modular connector, and the rod member,
whereby the pivotal modular connection pivotally connects the first and second display case modules.
